(19) United States
(12) Patent Application Publication
(10) Pub. No.: US 2016/0089802 A1
(43) Pub. Date: Mar. 31, 2016

(54) Knife Holder Assembly

(71) Applicants: James A. Gibson, Mercer, ME (US); Jeptha Gibson, Mercer, ME (US)

(72) Inventors: James A. Gibson, Mercer, ME (US); Jeptha Gibson, Mercer, ME (US)

(21) Appl. No.: 14/497,580

(22) Filed: Sep. 26, 2014

(51) Int. Cl. B26B 29/02; B26B 1/02

(52) U.S. Cl. CPC B26B 29/025; B26B 1/02

(57) ABSTRACT

A knife holder assembly for opening the knife when the knife is removed from the holder includes the knife structured to have a foldable blade. The holder is structured to removably contain the knife. A wheel is coupled to the holder. The blade on the knife engages the wheel when the knife is removed from the holder. The wheel unfolds the blade.

### BACKGROUND OF THE DISCLOSURE

1. Field of the Disclosure

The disclosure relates to holder devices and more particularly pertains to a new holder device for opening a knife when the knife is removed from the holder.

### SUMMARY OF THE DISCLOSURE

An embodiment of the disclosure meets the needs presented above by generally comprising a knife structured to have a foldable blade. A holder is provided. The holder is structured to removably contain the knife. A wheel is coupled to the holder. The blade on the knife engages the wheel when the knife is removed from the holder. The wheel unfolds the blade.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a perspective view of a knife holder assembly according to an embodiment of the disclosure.

FIG. 2 is a bottom view of an embodiment of the disclosure.

FIG. 3 is a cross sectional view taken along line 3-3 of FIG. 1 of an embodiment of the disclosure.

FIG. 4 is an in-use view of an embodiment of the disclosure.

FIG. 5 is a cross sectional view taken along line 5-5 of FIG. 1 of an embodiment of the disclosure.

### DESCRIPTION OF THE PREFERRED EMBODIMENT

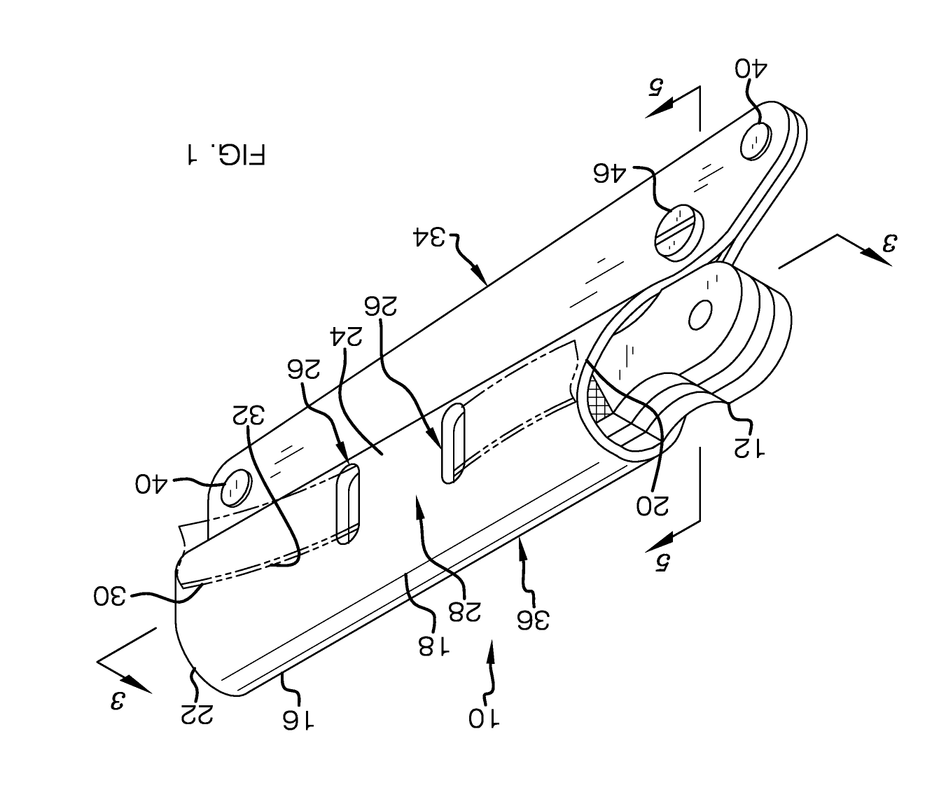

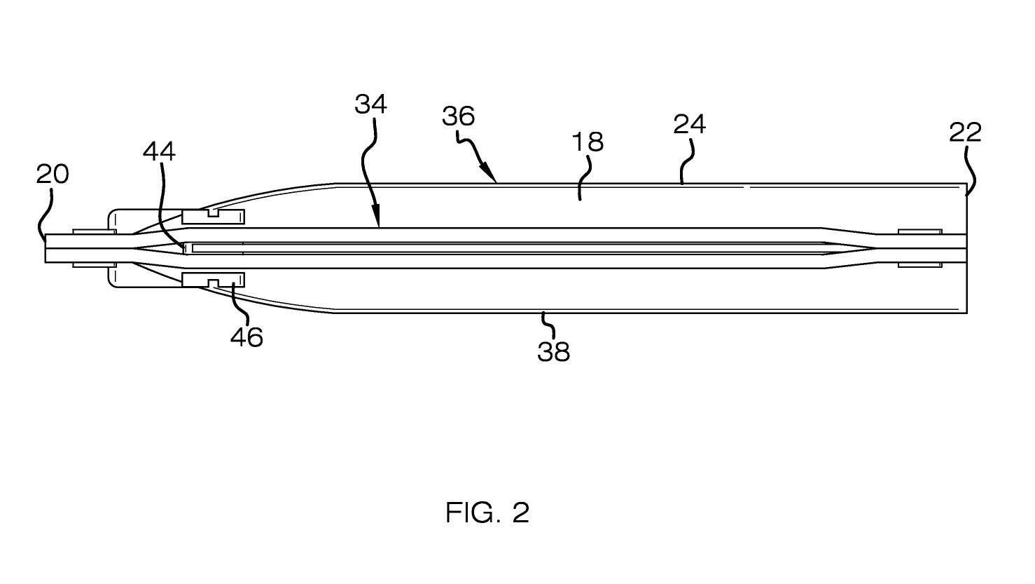

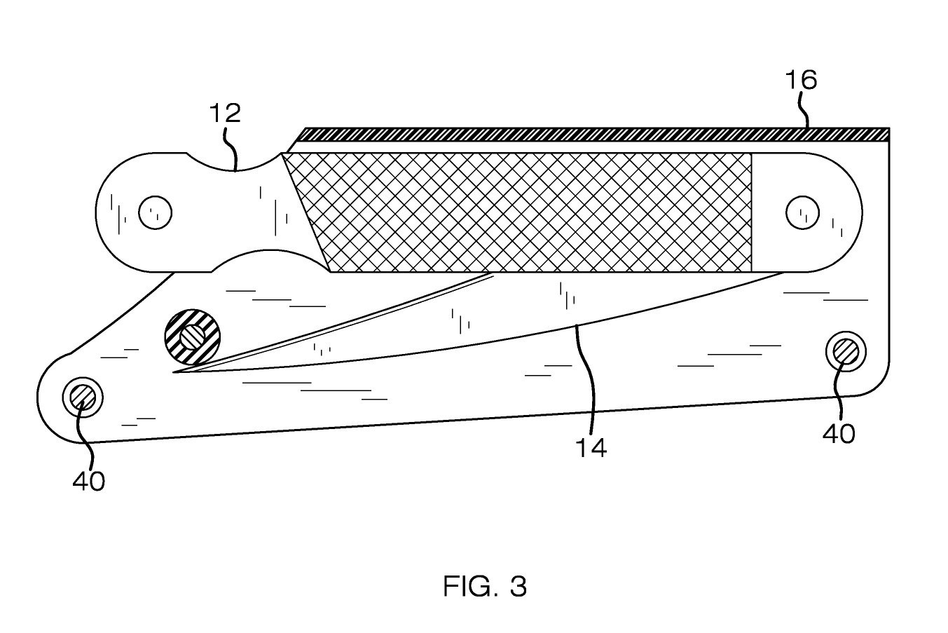

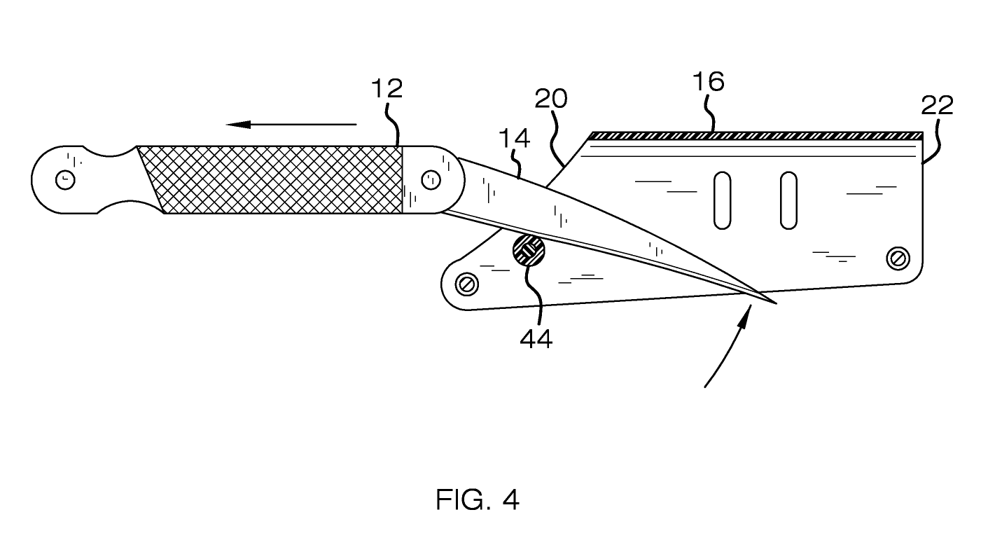

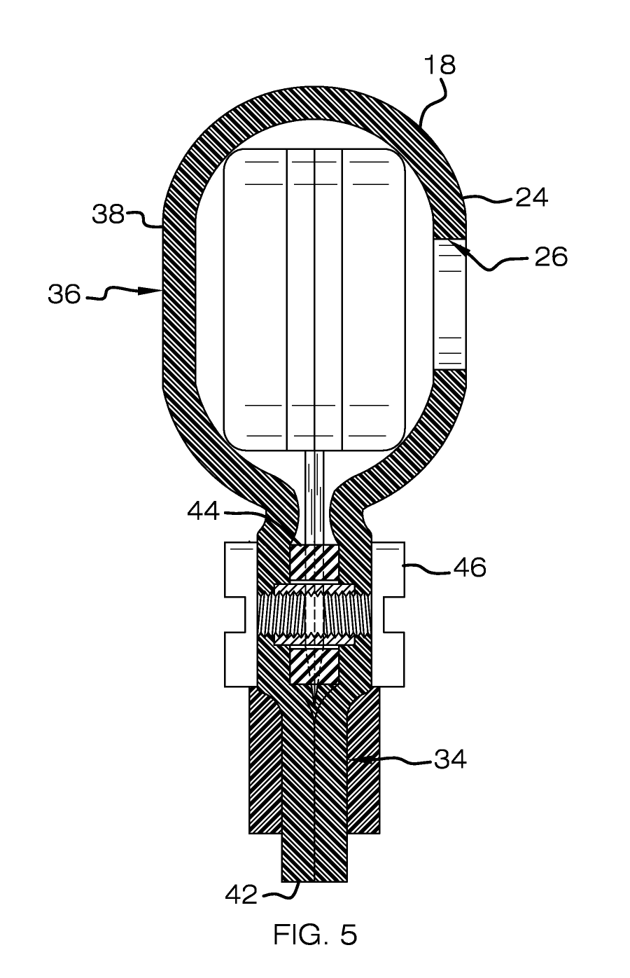

With reference now to the drawings, and in particular to FIGS. 1 through 5 thereof, a new holder device embodying the principles and concepts of an embodiment of the disclosure and generally designated by the reference numeral 10 will be described.

As best illustrated in FIGS. 1 through 5, the knife holder assembly 10 generally comprises a knife 12 structured to have a foldable blade 14. The knife 12 may be a jack knife of any conventional design. A holder 16 is provided. The holder 16 has an outer wall 18 extending between each of a front end 20 and a back end 22 of the holder 16. The front 20 and back 22 ends of the holder 16 are open. Moreover, the holder 16 is substantially hollow.

A first lateral side 24 of the outer wall 18 of the holder 16 has a pair of belt apertures 26 extending therethrough. The belt apertures 26 are evenly spaced apart from a middle 28 of the holder 16. A belt 30 may be threaded through the belt apertures 26 to retain the holder 16 on an article of clothing 32.

The outer wall 18 of the holder 16 has a flat section 34 and a round section 36 each extending between the front 20 and back 22 ends of the holder 16. Each of the first lateral side 24 and a second lateral side 38 of the outer wall 18 of the holder 16 are spaced apart a minimal distance in the flat section 34 of the holder 16. A pair of rivets 40 each extends through the first 24 and second 38 lateral sides of the outer wall 18 of the holder 16. The rivets 40 are each positioned proximate an associated one of the front 20 and back 22 ends of the holder 16. The rivets 40 fasten the first 24 and second 38 lateral sides of the outer wall 18 of the holder 16 together along a bottom edge 42 of the outer wall 18 of the holder 16.

The first 24 and second 38 lateral sides of the outer wall 18 of the holder 16 are spaced a maximum distance apart in the round section 36 of the holder 16. The knife 12 may be inserted through the front end 20 of the holder 16. Moreover, the knife 12 is positionable within the round section 36 of the holder 16.

A wheel 44 is rotatably coupled between the first 24 and second 38 lateral sides of the outer wall 18 of the holder 16. The wheel 44 is positioned in the flat section 34 of the holder 16. Additionally, the wheel 44 is positioned proximate the front end 20 of the holder 16. A screw 46 extends through each of the first 24 and second 38 lateral sides of the outer wall 18 of the holder 16. The screw 46 engages the wheel 44. The blade 14 on the knife 12 engages the wheel 44 when the knife 12 is removed from the holder 16. The wheel 44 unfolds the blade 14 when the knife 12 is removed from the holder 16.

In use, the knife 12 is carried in the holder 16 when the knife 16 is not in use. The wheel 44 opens the blade 14 as the knife 16 is removed from the holder 16. The assembly 10 prevents the blade 14 from being manually opened, thereby reducing a risk of injury.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A knife holder assembly comprising:
a knife structured to have a foldable blade;
a holder structured to removably contain said knife, comprising said holder having an outer wall extending between each of a front end and a back end of said holder, said front and back ends of said holder being open, said holder being substantially hollow, each of a first lateral side and a second lateral side of said outer wall of said holder being coupled together by an outermost spaced pair of rivets; and
a wheel coupled to said holder, said blade on said knife engaging said wheel when said knife is removed from said holder such that said blade is unfolded a space within said holder between said outermost spaced pair of rivets, said wheel, and a longitudinal edge of said holder being unobstructed.

2. (canceled)

3. The assembly according to claim 1, further comprising said outer wall of said holder having a flat section and a round section each extending between said front and back ends of said holder.

4. The assembly according to claim 3, further comprising each of said first lateral side and said second lateral side of said outer wall of said holder being spaced apart a minimal distance in said flat section of said holder.

5. The assembly according to claim 4, further comprising said first and second lateral sides of said outer wall of said holder being spaced a maximum distance apart in said round section of said holder wherein said knife is positionable within said round section of said holder.

6. The assembly according to claim 1, further comprising:
said outer wall of said holder having a flat section and a round section;
said outer wall of said holder having first lateral side and a second lateral side; and
said wheel being rotatably coupled between said first and second lateral sides of said outer wall of said holder such that said wheel is positioned in said flat section of said holder.

7. A knife holder assembly comprising:
a knife structured to have a foldable blade;
a holder, said holder having an outer wall extending between each of a front end and a back end of said holder, said front and back ends of said holder being open, said holder being substantially hollow, each of a first lateral side and a second lateral side of said outer wall of said holder being coupled together by an outermost spaced pair of rivets;
said outer wall of said holder having a flat section and a round section each extending between said front and back ends of said holder;
each of said first lateral side and said second lateral side of said outer wall of said holder being spaced apart a minimal distance in said flat section of said holder;
said first and second lateral sides of said outer wall of said holder being spaced a maximum distance apart in said round section of said holder wherein said knife is positionable within said round section of said holder; and
a wheel rotatably coupled between said first and second lateral sides of said outer wall of said holder such that said wheel is positioned in said flat section of said holder, said blade on said knife engaging said wheel when said knife is removed from said holder such that said blade is unfolded, a space within said holder between said outermost spaced pair of rivets, said wheel, and a longitudinal edge of said holder being unobstructed.
